(19) United States
(12) Patent Application Publication
(10) Pub. No.: US 2020/0307477 A1
(43) Pub. Date: Oct. 1, 2020

(54) VEHICLE SEATING ADJUSTMENT SYSTEM

(71) Applicant: Ford Global Technologies, LLC, Dearborn, MI (US)

(72) Inventor: Maria Gabriela Medrano Gonzalez, Cuautitlan Izcalli (MX)

(73) Assignee: Ford Global Technologies, LLC, Dearborn, MI (US)

(21) Appl. No.: 16/364,277

(22) Filed: Mar. 26, 2019

(51) Int. Cl. B60R 16/037; B60N 2/00; B60N 2/02; B60R 21/015

(52) U.S. Cl. CPC B60R 16/0373; B60N 2/002; B60N 2/0248; G05B 2219/45022; B60R 21/01546; B60N 2002/0272; G05B 2219/35453; B60R 21/01516

(57) ABSTRACT

A vehicle includes a vehicle control module and restraint control module operably coupled to the vehicle control module. A seating assembly is operable between a folded position and an unfolded position. A user-interface includes a microphone. The microphone receives a user command to adjust a seating position of the seating assembly and sends a request signal to the vehicle control module. The vehicle control module controls a seating position adjustment based on a start signal from the restraint control module.

### FIELD OF THE DISCLOSURE

The present disclosure generally relates to a vehicle seating adjustment system. More specifically, the present disclosure relates to a vehicle seating adjustment system operable via voice command.

### BACKGROUND OF THE DISCLOSURE

Folding and unfolding vehicle seats may be desired to allow for more storage space or more passenger seats, respectively, within a vehicle. Conventional seating systems may require a remote transmitter for operating the seating system. Other conventional seating systems may require the occupant to step out of the vehicle to access the seats to be folded.

### SUMMARY OF THE DISCLOSURE

According to at least one aspect of the present disclosure, a vehicle includes a vehicle control module and restraint control module operably coupled to the vehicle control module. A seating assembly is operable between a folded position and an unfolded position. A user-interface includes a microphone. The microphone receives a user command to adjust a seating position and sends a request signal to the vehicle control module. The vehicle control module starts a seating position adjustment based on a start signal from the restraint control module.

According to another aspect of the present disclosure, a vehicle includes a plurality of seating assemblies each operable between a folded position and an unfolded position. A user-interface includes a microphone and a speaker. The microphone is configured to receive a command to adjust a seating position and the speaker is configured to present predefined seating configuration options.

According to another aspect of the present disclosure, a vehicle seating adjustment system includes a seating assembly operable between a folded position and an unfolded position. A user-interface includes a microphone for receiving commands. A vehicle control module is operably coupled to the seating assembly and configured to adjust a seating position of the seating assembly. A restraint control module is operably coupled to the seating assembly. The restraint control module senses if the seating assembly is occupied and sends a corresponding signal to the vehicle control module.

These and other aspects, objects, and features of the present disclosure will be understood and appreciated by those skilled in the art upon studying the following specification, claims, and appended drawings.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a top perspective view of a passenger compartment of a vehicle, according to one example;

FIG. 2 is a top perspective view of the passenger compartment of the vehicle, according to one example;

FIG. 3 is a block diagram of the vehicle, according to one example; and

FIG. 4 is a flow diagram for a method of performing seating configurations within the vehicle, according to one example.

### DETAILED DESCRIPTION OF THE PREFERRED EMBODIMENTS

Additional features and advantages of the invention will be set forth in the detailed description which follows and will be apparent to those skilled in the art from the description, or recognized by practicing the invention as described in the following description, together with the claims and appended drawings.

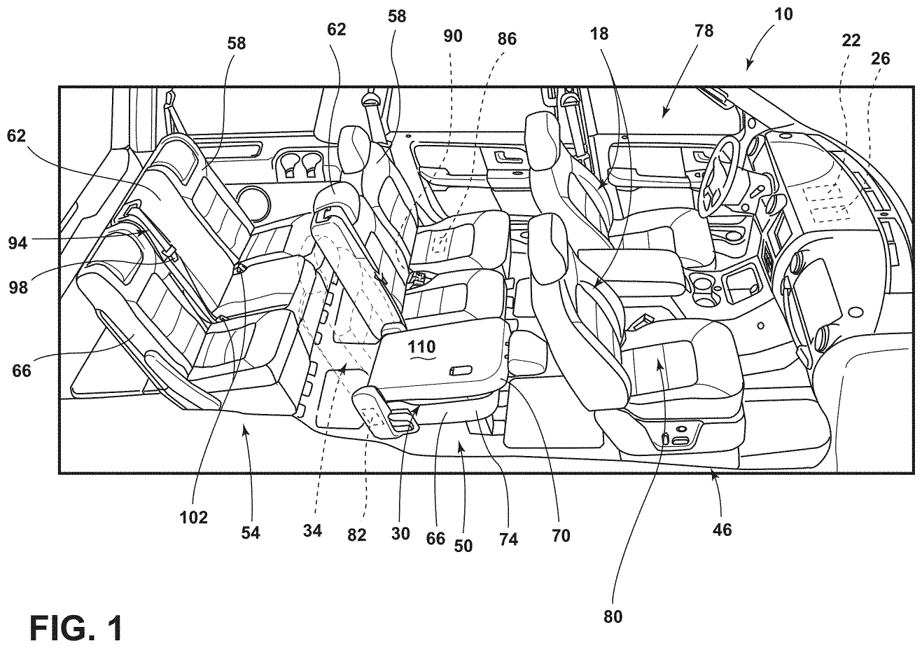

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Referring to FIGS. 1-4, reference numeral 10 generally refers to a vehicle having a system 14 for adjusting a plurality of seating assemblies 18 within the vehicle 10. The system 14 includes a vehicle control module 22 and a restraint control module 26 operably coupled to the vehicle control module 22. The seating assemblies 18 are each operable between a folded position 30 and an unfolded position 34. A user-interface 38 includes a microphone 42, wherein the microphone 42 receives a user command to adjust a seating position and sends a request signal to the vehicle control module 22. The vehicle control module 22 starts a seating position adjustment based on a start signal from the restraint control module 26.

Referring now to FIG. 1, it is contemplated that the vehicle 10 may include more or fewer seating rows than illustrated. The vehicle 10 may be a sedan, truck, sport utility vehicle, van, cross-over, or another type of vehicle 10. The vehicle 10 may be equipped with one or more seating assemblies 18. As illustrated, the vehicle 10 has the plurality of seating assemblies 18 arranged in a first front seating row 46, a second middle seating row 50, and a third rear seating row 54.

The second and third seating rows 50, 54 may each include a left seating assembly 58, a middle seating assembly 62, and a right seating assembly 66. It is also contemplated that the second and third seating rows 50, 54 include the left and right seating assemblies 58, 66 (e.g., no middle seating assembly 62). In various examples, each of the left, middle, and right seating assemblies 58, 62, 66 may be configured to move independently. In other examples, the left seating assembly 58 may be coupled to the middle seating assembly 62, such that the left and middle seating assemblies 58, 62 move together. It is also contemplated that the middle seating assembly 62 may be coupled to the right seating assembly 66. The second and third seating rows 50, 54 may have similarly structured seating assemblies 18. For example, the second and third seating rows 50, 54 may both have the left seating assembly 58 coupled to the middle seating assembly 62, the middle seating assembly 62 coupled to the right seating assembly 66, or each seating assembly 18 moving independently. Alternatively, the second and third seating rows 50, 54 may have different seating assembly structures.

Each of the seating assemblies 18 are operable between the folded position 30 and the unfolded position 34. In the folded position 30, a seat back 70 of each seating assembly 18 is positioned on and parallel to a seat base 74 of the respective seating assembly 18. The folded position 30 may be advantageous to provide more storage space within a passenger compartment 78 of the vehicle 10. In examples where each of the seating assemblies 18 of the second and third seating rows 50, 54 are in the folded position 30, the vehicle 10 may provide storage space (e.g., in a vehicle-rearward direction) behind the first seating row 46. In other words, the vehicle 10 may provide seating assemblies 18 for two passengers within the first seating row 46. In examples where the seating assemblies 18 of the third seating row 54 are in the folded position 30, the vehicle 10 may provide storage space behind the second seating row 50 and also provides seating assemblies 18 for up to five passengers. In examples where the seating assemblies 18 of the second and third seating rows 50, 54 are in the unfolded position 34, the vehicle 10 may provide storage space behind the third seating row 54 and seating assemblies 18 for up to eight passengers. In contrast, when in the unfolded position 34, the seatback 70 extends vertically upwards from the seat base 74 to provide a seating space 80 for a passenger.

Referring still to FIG. 1, the vehicle 10 includes the vehicle control module 22. The vehicle control module 22 may be configured as an electronic control unit that may control various electronic systems and/or subsystems of the vehicle 10. The vehicle control module 22 may be coupled to the restraint control module 26. In various examples, the vehicle control module 22 may be coupled to an engine control module, a powertrain control module, a transmission control module, a brake control module, a body control module, and/or any other control units or control modules within the vehicle. The vehicle control module 22 may also be coupled to positioning devices 82 of each of the seating assemblies 18. The vehicle control module 22 may send an electrical signal to each of the positioning devices 82 to activate the positioning devices 82. In various examples, the seating assemblies 18 may include a seat frame and the positioning device 82 may include an electric motor. The electric motor of the positioning device 82 may operate to move the seat frame of the seating assemblies 18. The vehicle control module 22 may send a fold signal or an unfold signal to the respective positioning device 82 to move the desired seating assembly 18 between the folded and unfolded positions 30, 34.

The restraint control module 26 may be configured as an electronic control unit positioned within the seating assemblies 18, or in another location within the vehicle 10. The restraint control module 26 may be operably coupled to an airbag and/or seatbelt pretensioner. The restraint control module 26 may also include sensors, such as, for example, a seat sensor 86 and a seatbelt buckle sensor 90. The seat sensor 86 may sense the presence of an occupant or other item on a respective seating assembly 18 when in the unfolded position 34. The seat sensor 86 may include, but is not limited to, any type of proximity sensor, seat airbag sensor, pressure sensor, ultrasonic sensor, capacitive sensor, or force sensor. In various examples, the seat sensor 86 may be positioned within the seat base 74 or the seat back 70 of the seating assembly 18. Additionally or alternatively, the restraint control module 26 may include a seatbelt buckle sensor 90. The seatbelt buckle sensor 90 may be positioned within a seatbelt assembly 94 coupled to the seating assembly 18 and configured to sense whether or not a seatbelt tongue 98 is positioned in a seatbelt buckle 102. In other words, the seatbelt buckle sensor 90 may also sense whether a specified seating assembly 18 is occupied with a passenger. It is also contemplated the sensors of the restraint control module 26 may be positioned in another location within the vehicle 10. The restraint control module 26 may include a plurality of restraint control modules 26 positioned in each of the seating assemblies 18. Alternatively, there may be a single restraint control module 26 operably coupled to the sensors positioned within or proximate to the seating assemblies 18. The restraint control module 26 may also be configured to sense if an object is positioned on a back surface 110 of the seat back 70 when the seating assembly 18 is in the folded position 30.

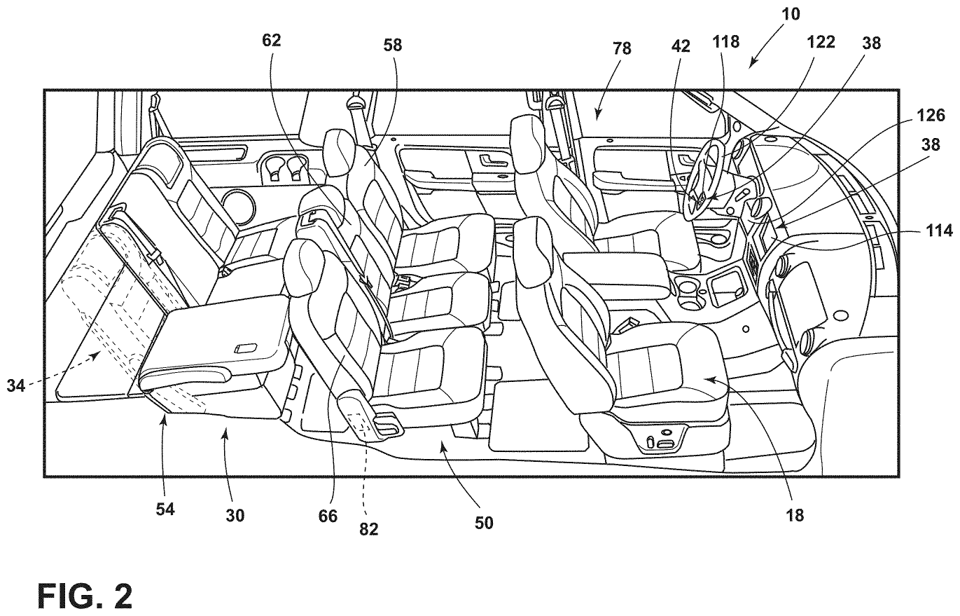

Referring now to FIGS. 1 and 2, in various examples, each of the seating assemblies 18 may include the positioning device 82 configured to adjust the seating position of the seating assembly 18. The seating position may include the folded and unfolded positions 30, 34. In other words, the positioning devices 82 may be configured to move the seating assemblies 18 between the folded and unfolded positions 30, 34. The positioning device 82 may be positioned within each seating assembly 18, within some seating assemblies 18, or in another location within the vehicle 10. The positioning devices 82 may also be configured to move the seating assemblies 18 in a vehicle fore-aft direction.

The seating assemblies 18 of the second and third rows 50, 54 may provide for a plurality of seating configurations, which may be predefined by a user. The desired seating configuration may be selected by an occupant of the vehicle 10. Based on the seating configuration selected by the occupant, different seating assemblies 18 may be moved to the folded position 30 or the unfolded position 34, respectively. In various examples, the seating configurations may include moving all the seating assemblies 18 within the second and third seating rows 50, 54 into the folded or unfolded position 30, 34; the left seating assembly 58 of the second seating row 50 to the folded or unfolded position 30, 34; the right seating assembly 66 of the second seating row 50 to the folded or unfolded position 30, 34; the middle seating assembly 62 of the second seating row 50 to the folded or unfolded position 30, 34; all seating assemblies 18 within the second seating row 50 to the folded or unfolded position 30, 34; the left seating assembly 58 within the third seating row 54 to the folded or unfolded position 30, 34; the right seating assembly 66 within the third seating row 54 to the folded or unfolded position 30, 34; the middle seating assembly 62 within the third seating row 54 to the folded or unfolded position 30, 34; all seating assemblies 18 within the third seating row 54 to the folded or unfolded position 30, 34; and/or combinations thereof. In other words, the predefined seating configurations may result in individual seating assemblies 18 moving and/or entire seating rows moving between the folded and unfolded positions 30, 34.

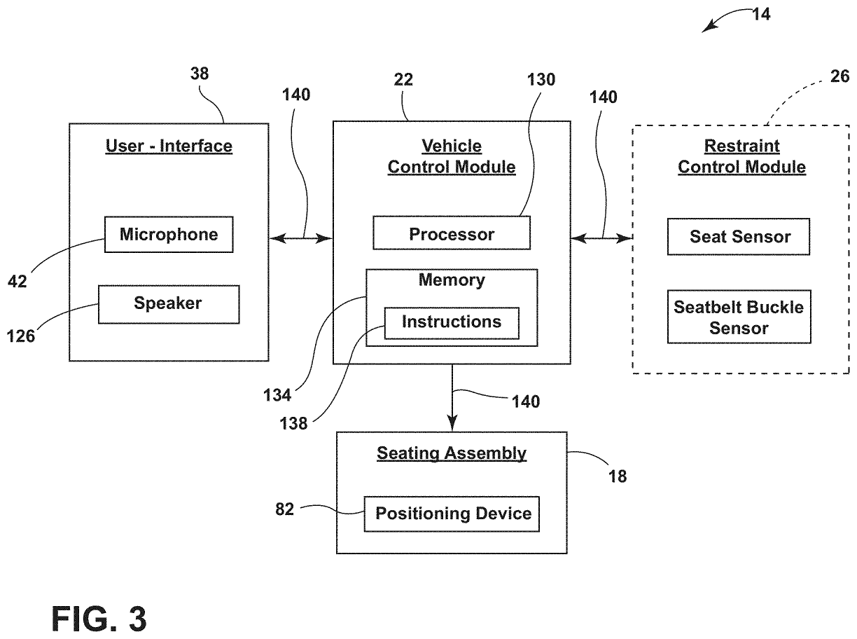

Referring still to FIGS. 1 and 2, as illustrated, the vehicle 10 includes the user-interface 38. The user-interface 38 may include, for example, a dial, switch, touch screen 114, and/or button 118. As shown in FIG. 2, the user-interface 38 includes the button 118 on a steering wheel 122. The location of the button 118 may be advantageous to allow a driver to interact with the user-interface 38 without letting go of the steering wheel 122 or looking to another location within the passenger compartment 78 of the vehicle 10. In various examples, the user-interface 38 includes the microphone 42 and a speaker 126. In such examples, the user-interface 38 may be operated via a voice command from the vehicle occupants. Operating the system 14 (FIG. 3) via the voice command may provide a substantially hands-free method of moving the seating assemblies 18 between the folded and unfolded positions 30, 34. The microphone 42 and speaker 126 may be located proximate to a driver seat; however, it is contemplated that the microphone 42 and speaker 126 may be positioned in other locations of the passenger compartment 78. There may be more than one microphone 42 and/or speaker 126 to allow a passenger in the first, second, and/or third seating rows 46, 50, 54 to interact with the user-interface 38 once activated.

Referring now to FIG. 3, within the system 14 the vehicle control module 22 may be coupled to the restraint control module 26, the user-interface 38, and the positioning devices 82 of each of the seating assemblies 18. The vehicle control module 22 may include a processor 130, other control circuitry, and a memory 134. Stored in the memory 134 and executable by the processor 130 are instructions 138. The memory 134 may store various instructions 138 relating to various functions. The instructions 138 may include at least one instruction 138 for adjusting the seating position of each of the seating assemblies 18. The memory 134 may also store various seating configuration options that an occupant may select through the user-interface 38. Additionally or alternatively, the user-interface 38 may store the seating configuration options. The user-interface 38 and/or the vehicle control module 22 may also store personalized seating configurations for different users. In various examples, the vehicle control module 22 may communicate with each of the user-interface 38, the restraint control module 26, and the positioning devices 82 via a controller area network (CAN) bus 140.

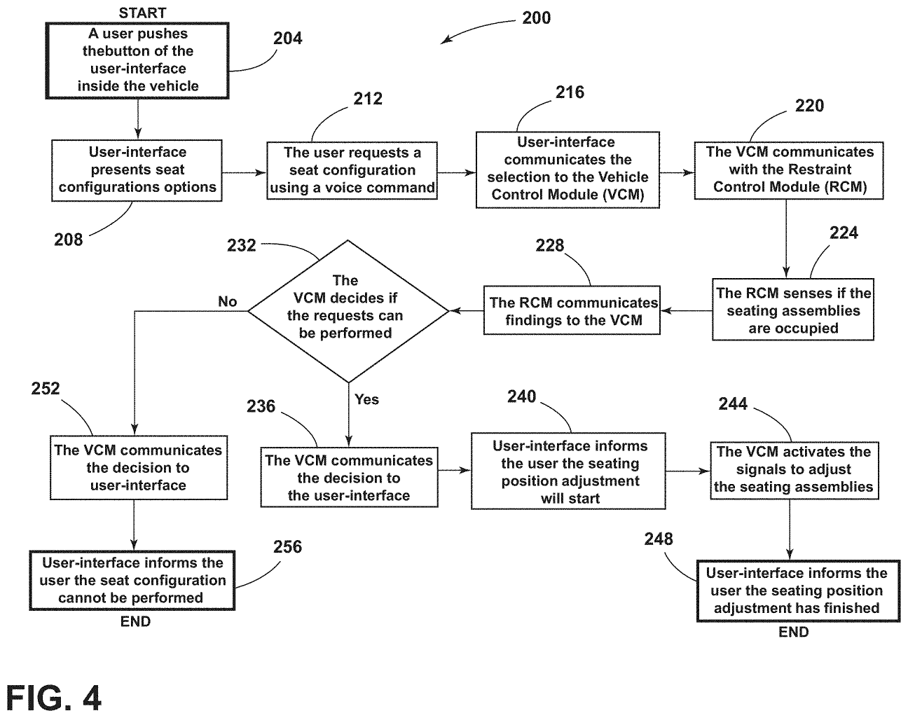

Referring now to FIGS. 1 and 4, in operation, the vehicle control module 22 and the restraint control module 26 may cooperate to adjust the seating position of specified seating assemblies 18 while the vehicle 10 is in motion. A method 200 for performing seating configurations and adjusting the seating position of the seating assemblies 18 begins with a step 204 where an occupant or user activates the user-interface 38. In a specific example, the user may press the button 118 on the steering wheel 122 to activate the user-interface 38. The user may press the button 118 while the vehicle 10 is stationary or while the vehicle is in motion (e.g., when actively being driven).

In response, at a step 208, the user-interface 38 may present to the user the seating configuration options available. The seating configuration options may be stored within the user-interface 38 or within the vehicle control module 22. The seating configuration options may be predefined by the user and/or may be determined by the model of the vehicle 10. The user-interface 38 includes the speaker 126 for presenting the various seating configuration options to the user.

Next, at a step 212, the user may request a seating configuration option via a command.

In various examples, the command is a voice command given via the microphone 42 of the user-interface 38. It is also contemplated that the command may be given in additional or alternative methods, such as, for example, via the touch screen 114. The voice command may specify the desired seating assemblies 18 and whether the seating assemblies 18 should be moved to the folded position 30 or the unfolded position 34. The voice command may also operate to select one of the predefined seating configuration options. In other words, the microphone 42 is configured to receive a command to adjust the seating position of various seating assemblies 18 within the vehicle 10. In various examples, a specified number may relate to each of the predefined seating configuration options. For example, the number “1” spoken by the user may relate to moving the desired seating assembly 18 to the folded position 30, and the number “2” spoken by the user may relate to moving the desired seating assembly 18 to the unfolded position 34. In such examples, each of the seating configurations may have a specified number that represents the seating configuration. In additional or alternative examples, a voice command of “1.1” may correspond to moving the entire second and third seating rows 50, 54 to the folded position 30, “1.2” may correspond to moving the entire second seating row 50 to the folded position 30, “1.3” may correspond to moving the left seating assembly 58 of the second seating row 50 to the folded position 30, “1.4” may correspond to moving the right seating assembly 66 of the second seating row 50 to the folded position 30, “1.5” may correspond to moving the entire third seating row 54 to the folded position, “1.6” may correspond to moving the left seating assembly 58 of the third seating row 54 to the folded position 30, “1.7” may correspond to moving the right seating assembly 66 of the third seating row 54 to the folded position 30, and/or combinations thereof. It is also contemplated that predetermined specified numbers may correspond to moving various seating assemblies 18 to the unfolded position 34. It is further contemplated that predetermined specified numbers may correspond to moving various seating assemblies 18 in the fore-aft direction of the vehicle 10 separately or in combination with the seating assemblies 18 being moved between the folded and unfolded positions 30, 34. Additionally, it is contemplated that other numbers, words, and/or phrases may correspond to the various seating operations and/or configurations.

In a step 216, the user-interface 38 communicates the selection of the seating configuration to the vehicle control module 22. The user-interface 38 transforms the voice command into an electrical signal to send to the vehicle control module 22. In other words, the user-interface 38 sends a request signal to the vehicle control module 22 corresponding to the seating configurations requested and/or selected by the user. In response, at a next step 220, the vehicle control module 22 communicates the request signal to the restraint control module 26. In various examples, the vehicle control module 22 may wait to adjust the seating position of the specified seating assemblies 18, and/or implement the selected seating configuration until the vehicle control module 22 receives a start signal from the restraint control module 26. Additionally or alternatively, the request signal sent from the vehicle control module 22 to the restraint control module 26 may specify each seating assembly 18 to be adjusted.

The method 200 may include a step 224 where the restraint control module 26 senses if each of the seating assemblies 18 specified by the user are occupied. In such examples, the restraint control module 26 may be coupled to each of the seating assemblies 18. The restraint control module 26 may use the seat sensor 86 and/or the seatbelt buckle sensor 90 (FIG. 3) to sense whether a passenger and/or an object is positioned on the seating assemblies 18. In various examples, the restraint control module 26 may sense if a passenger or object is positioned on the seat base 74 of the seating assembly 18, against the seat back 70 of the seating assembly 18, or a combination thereof where the seating assembly 18 is in the unfolded position 34. In various examples, the restraint control module 26 may also sense whether an object is positioned on the seat back 70 when the seating assembly 18 is in the folded position 30.

Next, in a step 228, the restraint control module 26 communicates the determination of whether or not the specified seating assemblies 18 are occupied, or otherwise have objects positioned on the seating assemblies 18, to the vehicle control module 22. If the selected seating assemblies 18 are sensed as being unoccupied or otherwise unobstructed, the restraint control module 26 may communicate a start signal to the vehicle control module 22. Alternatively, if the selected seating assemblies 18 are sensed as being occupied or otherwise obstructed, the restraint control module 26 may send a stop signal to the vehicle control module 22. In various examples, the restraint control module 26 may send the start signal corresponding to some of the seating assemblies 18 and the stop signal corresponding to other seating assemblies 18. In other words, the restraint control module 26 senses if the specified seating assemblies 18 are occupied or otherwise obstructed and sends a corresponding signal to the vehicle control module 22.

Next, in a decision step 232, based on the signal received from the restraint control module 26, the vehicle control module 22 determines whether the request and/or command of the user can be performed. In other words, the vehicle control module 22 may determine whether to adjust the seating position of the seating assemblies 18 based on the signal received from the restraint control module 26. The vehicle control module 22 may include at least one instruction 138 (FIG. 3) relating to the determination of whether to institute the user request or not. If the vehicle control module 22 determines that the request can be implemented, the vehicle control module 22 communicates the decision to proceed to the user-interface 38 in a step 236.

In a step 240, the user-interface 38 communicates the decision of the vehicle control module 22 to proceed with the request to the user and/or the vehicle occupants. In other words, the user-interface 38 may convey the decision of the vehicle control module 22 via the speaker 126. The user-interface 38 may also inform the user that the seating position adjustment will start. The seating position adjustment may correspond with moving the seating assemblies 18 to the folded position 30 or the unfolded position 34. The specified adjustment (e.g., to the folded or unfolded positions 30, 34) may also be repeated by the user-interface 38 via the speaker 126 as a confirmation of the voice command.

Next, in a step 244, the vehicle control module 22 activates signals to adjust the seating positions of the specified seating assemblies 18. The vehicle control module 22 may send an electrical signal to the positioning devices 82 of the seating assemblies 18 to be folded, unfolded, or otherwise adjusted. In various examples, the vehicle control module 22 may perform multiple seating configuration options simultaneously. For example, the left seating assembly 58 of the second seating row 50 may be moved to the folded position 30 while the right seating assembly 66 of the third seating row 54 is moved to the unfolded position 34 (FIG. 1). In other words, the vehicle control module 22 is configured to adjust seating positions of the seating assemblies 18 based on a selected configuration option or a combination of options. Each of the seating position adjustments may be performed while the vehicle 10 is in motion. Additionally or alternatively, the step 244 may provide for the user to cancel or stop the seating position adjustment. The user may give an additional voice command to stop and/or cancel the seating position adjustment, which may be conveyed to the vehicle control module 22, which then may send a corresponding signal to the positioning devices 82 of the specified seating assemblies 18. A user may cancel all seating position adjustments or some of the seating position adjustments. In some examples, the user may push the button 118 of the user-interface 38 to give the command. In other examples, the user may give a command without pushing the button 118 or otherwise indicating a command to be input into the user-interface 38 (FIG. 1). If the user does not stop or cancel the seating position adjustment, the vehicle control module 22 may continue to adjust the seating position until the seating assemblies 18 are in the desired seating position (e.g., the folded or unfolded positions 30, 34).

After the completion of the seating position adjustment, in a step 248 the user-interface 38 may inform the user that the adjustment is completed. The user may be informed via the speaker 126 or otherwise notified, for example, by the touch screen 114.

Returning to the decision step 232, if the restraint control module 26 senses the seating assemblies 18 are occupied or otherwise obstructed, the method 200 proceeds to a step 252 where the vehicle control module 22 communicates the decision not to proceed with the seating position adjustment to the user-interface 38. In such examples, the method 200 then proceeds to a step 256 where the user-interface 38 informs the user that the seat configuration may not be performed. In various examples, the user may be informed via the speaker 126 of the user-interface 38. The user may be informed that all of the seating configurations may not be performed, or that some of the seating configurations may not be performed.

Use of the present disclosure may provide a variety of advantages. In a first example, the use of voice commands to adjust the seating positions of the seating assemblies 18 within the vehicle 10 may limit driver distraction. In a second example, the presently disclosed system 14 for adjusting the seating position of the seating assemblies 18 may reduce manufacturing and production costs. In a third example, the presently disclosed system 14 may provide for additional storage space within the vehicle 10. In a fourth example, the storage space may be increased or decreased while the vehicle 10 is in motion, thereby allowing the user to save time adjusting the seating configuration of the vehicle 10.

According to various examples, a vehicle includes a vehicle control module and restraint control module operably coupled to the vehicle control module. A seating assembly is operable between a folded position and an unfolded position. A user-interface includes a microphone. The microphone receives a user command to adjust a seating position of the seating assembly and sends a request signal to the vehicle control module. The vehicle control module controls a seating position adjustment based on a start signal from the restraint control module. Embodiments of the present disclosure may include one or a combination of the following features:
the vehicle control module is configured to adjust the seating position of the seating assembly while said vehicle is in motion;
the restraint control module senses if the seating assembly is occupied via a sensor;
the restraint control module sends the start signal to the vehicle control module if the seating assembly is sensed as being unoccupied;
the restraint control module sends a stop signal to the vehicle control module if the seating assembly is sensed as being occupied;
the seating assembly includes a positioning device configured to move the seating assembly between the folded and unfolded positions based on a signal from the vehicle control module;
the user-interface includes a speaker for signaling start and completion of the seating position adjustment;
the seating assemblies are positioned in at least one of first, second, and third seating rows;
the predefined seating configuration options include options to adjust the second and third seating rows between the folded and unfolded positions;
each of the plurality of seating assemblies comprises a positioning device operably coupled to the vehicle control module;
the vehicle control module is configured to perform multiple seating configuration options simultaneously;
a force sensor within the seating assembly operably coupled to the restraint control module;
a seatbelt coupled to the seating assembly;
a seatbelt lock sensor operably coupled to the restraint control module;
the vehicle control module determines whether to adjust the seating position of the seating assembly based on the signal received from the restraint control module;
the speaker signals the determination of the vehicle control module; and
the speaker signals a start and a completion of the seating position adjustment.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle, comprising:
a vehicle control module;
a restraint control module operably coupled to the vehicle control module;
a seating assembly operable between a folded position and an unfolded position; and
a user-interface including a microphone, wherein the microphone receives a user command to adjust a seating position of the seating assembly and sends a request signal to the vehicle control module, and wherein the vehicle control module controls a seating position adjustment based on a start signal from the restraint control module.

2. The vehicle of claim 1, wherein the vehicle control module is configured to adjust the seating position of the seating assembly while said vehicle is in motion.

3. The vehicle of claim 1, wherein the restraint control module senses if the seating assembly is occupied via a sensor.

4. The vehicle of claim 3, wherein the restraint control module sends the start signal to the vehicle control module if the seating assembly is sensed as being unoccupied.

5. The vehicle of claim 3, wherein the restraint control module sends a stop signal to the vehicle control module if the seating assembly is sensed as being occupied.

6. The vehicle of claim 1, wherein the seating assembly includes a positioning device configured to move the seating assembly between the folded and unfolded positions based on a signal from the vehicle control module.

7. The vehicle of claim 1, wherein the user-interface includes a speaker for signaling start and completion of the seating position adjustment.

8. A vehicle, comprising:
a plurality of seating assemblies each operable between a folded position and an unfolded position;
a user-interface including a microphone and a speaker, wherein the microphone is configured to receive a command to adjust a seating position and the speaker is configured to present predefined seating configuration options; and
a vehicle control module operably coupled to the seating assemblies and configured to adjust seating positions of the seating assemblies based on a selected configuration option.

9. The vehicle of claim 8, wherein the seating assemblies are positioned in at least one of first, second, and third seating rows.

10. The vehicle of claim 9, wherein the predefined seating configuration options include options to adjust the second and third seating rows between the folded and unfolded positions.

11. The vehicle of claim 8, wherein the predefined seating configuration options include options to adjust individual seating assemblies between the folded and unfolded positions.

12. The vehicle of claim 8, wherein each of the plurality of seating assemblies comprises a positioning device operably coupled to the vehicle control module.

13. The vehicle of claim 8, wherein the vehicle control module is configured to perform multiple seating configuration options simultaneously.

14. The vehicle of claim 8, further comprising:
a restraint control module configured to sense whether a desired seating assembly is occupied.

15. A vehicle seating adjustment system, comprising:
a seating assembly operable between a folded position and an unfolded position;
a user-interface including a microphone for receiving commands;
a vehicle control module operably coupled to the seating assembly and configured to adjust a seating position of the seating assembly; and
a restraint control module operably coupled to the seating assembly, wherein the restraint control module senses if the seating assembly is occupied and sends a corresponding signal to the vehicle control module.

16. The vehicle seating adjustment system of claim 15, further comprising:
a force sensor within the seating assembly operably coupled to the restraint control module.

17. The vehicle seating adjustment system of claim 15, further comprising:
a seatbelt coupled to the seating assembly; and
a seatbelt lock sensor operably coupled to the restraint control module.

18. The vehicle seating adjustment system of claim 15, wherein the vehicle control module determines whether to adjust the seating position of the seating assembly based on the signal received from the restraint control module.

19. The vehicle seating adjustment system of claim 18, wherein the speaker signals the determination of the vehicle control module.

20. The vehicle seating adjustment system of claim 15, wherein the speaker signals a start and a completion of the seating position adjustment.
